(19) United States
(12) Patent Application Publication
(10) Pub. No.: US 2016/0004729 A1
(43) Pub. Date: Jan. 7, 2016

(54) System and Method for Managing and Using Data Model

(71) Applicant: Aaron Evans, San Francisco, CA (US)

(72) Inventor: Aaron Evans, San Francisco, CA (US)

(73) Assignee: JUMBO, INC., San Francisco, CA (US)

(21) Appl. No.: 14/853,288

(22) Filed: Sep. 14, 2015

Related U.S. Application Data
(60) Provisional application No. 62/071,041, filed on Sep. 13, 2014.
(60) Provisional application No. 62/125,951, filed on Feb. 4, 2015.

(51) Int. Cl. G06F 17/30; H04L 29/06

(52) U.S. Cl. CPC G06F 17/30294; H04L 67/42

(57) ABSTRACT

Disclosed is a system and method for defining data structures for client-server system. In one embodiment, the present invention provides a compiler-enforced data model across distributed systems for providing system stability and the ability to identify and fix violations of the data model contract in a more efficient manner.

### CROSS-REFERENCE TO RELATED APPLICATIONS

This application claims the benefit of U.S. Provisional Patent Application No. 62/071,041, filed Sep. 13, 2014, and U.S. Provisional Patent Application No. 62/125,951, filed Feb. 4, 2015, which are hereby incorporated by reference in their entirety.

### FIELD OF THE INVENTION

The present invention generally relates to a software development tool and services for client and server applications. More particularly, the present invention is directed to a system and method for managing and using a data model for a distributed application such as a server application, a mobile client application, a web application, and the like.

### BACKGROUND OF THE INVENTION

Updating and managing a data model is a constant challenge for many software developers as any change in the data model of a distributed application impacts many parts of the distributed application. For example, a single change to a data structure, no matter how simple or minor, affects multiple components in a system such as a data storage, a data binding module, a model, and an Application Programming Interface (API) of one or more distributed applications as well as data packet structures.

Currently, there exists no convenient methodology for software developers to design and deliver structured client-server data. This can be especially problematic for many mobile application developers as mobile applications are exponentially growing in popularity and use, yet many web services for mobile phone consumption comprises weakly typed data.

The data structures of the existing systems in particular are not well defined, and therefore it is difficult to maintain code across distributed systems that are dependent upon them, or effectively monitor and produce usage statistics against them. Thus, changes to data structures can create a substantial impact across heterogeneous systems with a plurality of heterogeneous distributed applications. In this regard, there is a need in the prior art for an improved means to design and deliver structured client-server data.

Some systems utilize JavaScript object notation (JSON) or similar data-exchange format that is based upon a scripted language. While JSON is a good delivery mechanism for mobile because of its compact format, it is limited in that it is not typesafe and that it does not adequately define a data model. Moreover, there is no truly practical way to define and enforce a data model construct or contract because developers cannot modify a data model in a compiler-verified manner, particularly for distributed systems such as mobile client-server applications.

The present invention overcomes the foregoing limitations by disclosing a system and method that allows software developers to readily design distributed data models. In this regard, the invention not only enhances the overall system stability and flexibility, but also improves on the ability to track usage of the data. This in-turn allows various stakeholders to better view or audit system and data usage claims.

### SUMMARY OF THE INVENTION

In view of the disadvantages inherent in the known types of systems for creating and using data models now present in the prior art, the present invention provides an improved system and method for defining data structures for a client-server system in an efficient manner.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In a preferred embodiment, the present invention provides a compiler-enforced data model across distributed systems. This helps improve system stability and provides the ability to identify and fix violations of the data model contract in a more predictable and manageable manner. In this regard, the present invention enables users to deliver data in the popular JSON as well as XML formats.

It is therefore an object of the present invention to resolve development challenges of heterogeneous mobile devices running on Android (Java), iOS (Objective-C), and other mobile devices (e.g., Chrome).

It is another object of the present invention to allow software developers to readily design distributed data models, whereby allowing the developers to design the data models enhances the overall system stability and flexibility, and improves on the ability to track usage of the data.

It is still another object of the present invention to provide a system that comprises a data model that is orthogonal to the view and controller to minimize the amount of code changes when required.

It is still another object of the present invention to define a master schema that defines data structures for the entire client-server system and that uses compilers to confirm that the data structures conform to the schema.

It is still another object of the present invention to dramatically reduce the time it takes to write, test, and troubleshoot source code in a distributed system.

It is still another object of the present invention to simplify the impact of updating source code by the use of schemas and source code generators to automatically re-generate or modify the source code related to distributed applications.

It is still another object of the present invention to report and identify issues and their locations within the code base as necessary.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is an exemplary embodiment of the present invention.

FIG. 2 is a detailed view of the master schema, the schema generator, and schemas of the present invention.

FIG. 3 shows an exemplary embodiment of the present system.

FIG. 4 shows a view of the master schema in operation.

FIG. 5 shows a view of an exemplary computer system within which it comprises the components of the present invention.

### DETAILED DESCRIPTION OF THE INVENTION

The present invention is directed towards a system and method for managing and using data models. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through the use of artificial intelligence techniques.

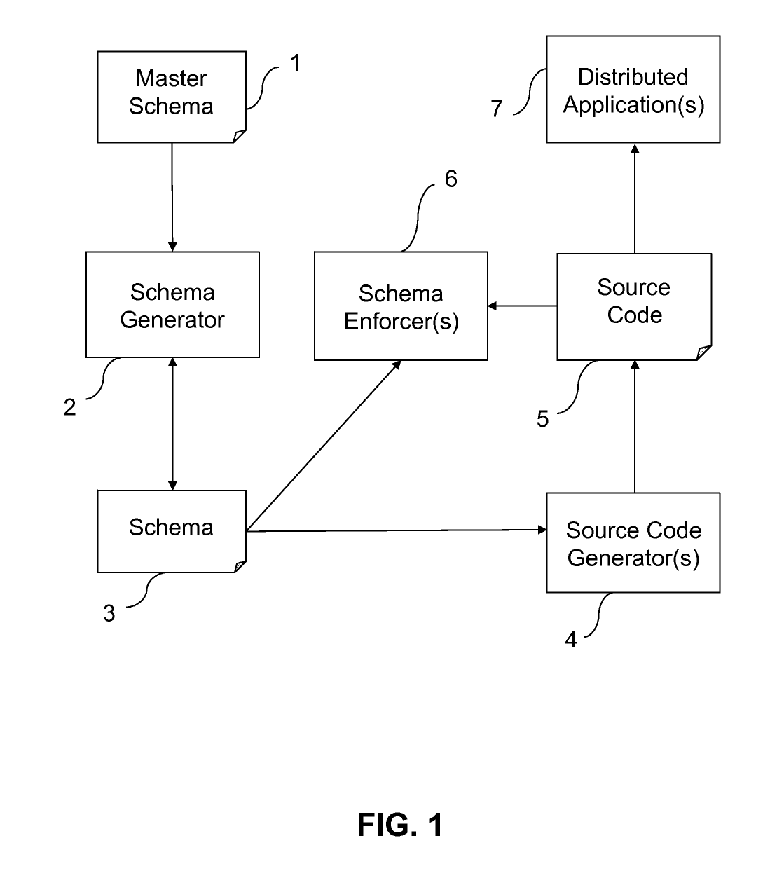

Referring now to FIG. 1, there is shown an exemplary block diagram of the present invention. The present invention comprises a computer system within which it comprises a computer program or a component software, hereinafter referred to as the Schema Generator 2 that reads a Master Schema 1 describing the data model of one or more distributed applications to generate one or more Schemas 3.

The Master Schema 1 can be derived from multiple sources, in whole or in part using an automated and/or a manual process. In one embodiment of the present invention, the Master Schema 1 can be derived from structured data such as a JSON payload, in whole or in part. In another embodiment, part of all of the Master Schema 1 can also be derived from the source code of enterprise applications or client applications, or from the annotations to source code of the enterprise or client applications, e.g., JAXB or JPA annotations. In still another embodiment, part of all of the Master Schema 1 may be derived by an API's discovery or introspection facilities, e.g., the Web Services Description Language (WSDL), payload of a Simple Object Access Protocol (SOAP) interface, etc.

The present invention further comprises one or more Source Code Generators 4. The Source Code Generator 4 comprises a computer programs or component such as Integrated Development Environment (IDE) that generates data objects and views. The Source Code Generator 4 reads one or more Schemas 3, and that generates a Source Code 5 consistent with a schema or a system model. More specifically, the Source Code Generator 4 generates the Source Code 5. In some embodiments, the Source Code 5 may be part of a SDK. Non-limiting examples of Source Code 5 includes: Java Architecture for XML Binding (JAXB) markup, annotations, and configuration files, Hibernate or JPA markup, annotations and configuration files, serializers that are capable of generating structured data packets, and API introspection facilities, e.g., Web Services Description Language (WSDL) among others.

In an alternate embodiment, Source Code Generators 4 may consume the Master Schema 1, wherein the Master Schema 1 contains annotations or similarly functioning identifiers, which the Source Code Generator 4 may use to identify the relevant portions of the Master Schema 1 for the purposes of generating or modifying source code.

The present invention further comprises one or more Schema Enforcers 6, wherein the Schema Enforcers 6 comprise one or more computer programs or components that acts as a source code compiler such as a Java compiler or an iOS compiler, and compiles or links the Schema 3 as part of the build process to create the Distributed Application 7. Alternatively, Schema Enforcers 6 comprise virtual machines (VMs), interpreters, and the like.

In an alternate embodiment, the Schema Enforcer 6 compiles or links the Master Schema 1, wherein the Master Schema 1 contains annotations relevant to the Schema Enforcer 6. For example, annotations may indicate that a portion of the Master Schema 1 is relevant to the database binding, e.g., @db, @hql, @sql, etc., relevant to the client only, e.g., @client, relevant to its data objects, e.g., @client-do, relevant to server data objects, e.g., @server-do, relevant to application programming interfaces, e.g., @api, @depth, to indicate for example the depth or number of nested complex types to serialize, and so forth. The Distributed Application 7 may be a component of a larger distributed system such as a server application, a mobile client application, a web application, etc.

One or more Schemas 3 may be derived from the Master Schema 1 via a Schema Generator 2. One or more Source Code Generators 4 may read one or more Schemas 3 and generate Source Code 5 on behalf of software developers. Source code generation may include, but is not limited to generating database schemas, database queries or stored procedures, class files for generating objects such as Plain Old Java Objects (POJOs), Android or iOS data objects, Android or iOS user interface objects, serializers, parsers, transport schemas, and APIs. Once generated, the Source Code 5 is linked or compiled into one or more Distributed Applications 7. Alternatively, the Source Code 5 may be compiled into classes, and then directly injected e.g., via Java, into the Distributed Application 7.

Accordingly, the Distributed Application 7 contains the Source Code 5 that can either be manually written or generated along with binaries and other classes. The Distributed Application 7 may comprise: JAXB source code, object code, or binaries, which is capable of generating Java objects from XML (or JSON) and XML (or JSON) from Java objects of classes; and Hibernate or JPA binaries, source code, or object code, which is capable of generating SQL scripts and stored procedures from Hibernate markup, annotations, and configuration files. In this regard, the Distributed Application 7 is configured to read the markups generated in the Source Code 5.

In one embodiment, the Master Schema 1 and/or the Schemas 3 may contain annotations or other suitable identifiers and identifying means, which address runtime behavior. In this regard, the Source Code Generator 4 can read the annotations and can generate a Schema 3 that may contain artifacts representing the annotations. For example, annotations may restrict the Source Code 5 or identify a design pattern or behavior for addressing more challenging operations, such as serializing or deserializing nested complex data structures or objects, e.g., @custom, @restrict, @no-serialize, etc. For example, an annotation, e.g., @dirty, @delta, @change-only, might indicate to the Source Code 5 such that it identifies the ID of an object or data structure whose contents have changed, the object having a parent object and multiple child objects, the Source Code 5 serializing only the object that changed from the Distributed Application 7, and deserializing the object on the corresponding client or server's Distributed Application 7.

The present invention allows software developers to create their own Source Code 5, whereby the Schema Enforcer 6 ensures that the Source Code 5 complies with the requirements of the Schema(s) 3. The Source Code 5 may be any program language such as C, C++, C#, Java, Scala, JavaScript, Pascal, Fortran, Perl, Matlab, SAS, SPSS, AJAX, or Objective-C, among others. An ordinary person skilled in the art will appreciate that Source Code 5 may consist of database schemas, database queries and stored procedures, server classes and their object instances, APIs, serializers, transport layer schemas, and parsers and server side classes and their object instances, among other components.

One advantage of using code generation in conjunction with code enforcement is that minor changes such as adding a single attribute that necessarily changes database code, e.g., schemas, database queries, stored procedures or other data bindings, class structure, API, transport layer, client side classes, and UI classes, etc. can be generated from one or more Schemas 3 and Source Code Generators 4.

The Schema Enforcers 6, distributed throughout the system, can ensure that the Source Code 5 generated via the Source Code Generators 4 and/or modified Source Code 5 are compliant with the Schema(s) 3. One benefit of this embodiment is that changes that propagate throughout a distributed system can be iterated rapidly. Another benefit of this embodiment is that it can generate source code without utilizing costly resources.

Without limitation, Distributed Applications 7 may comprise server-based applications, client-based applications, and/or other applications, wherein the applications are operated via various computer systems. The Source Code 5 may be created via Schema 3 and Source Code Generators 4 to serve client, server, or other distributed application purposes such as network communications.

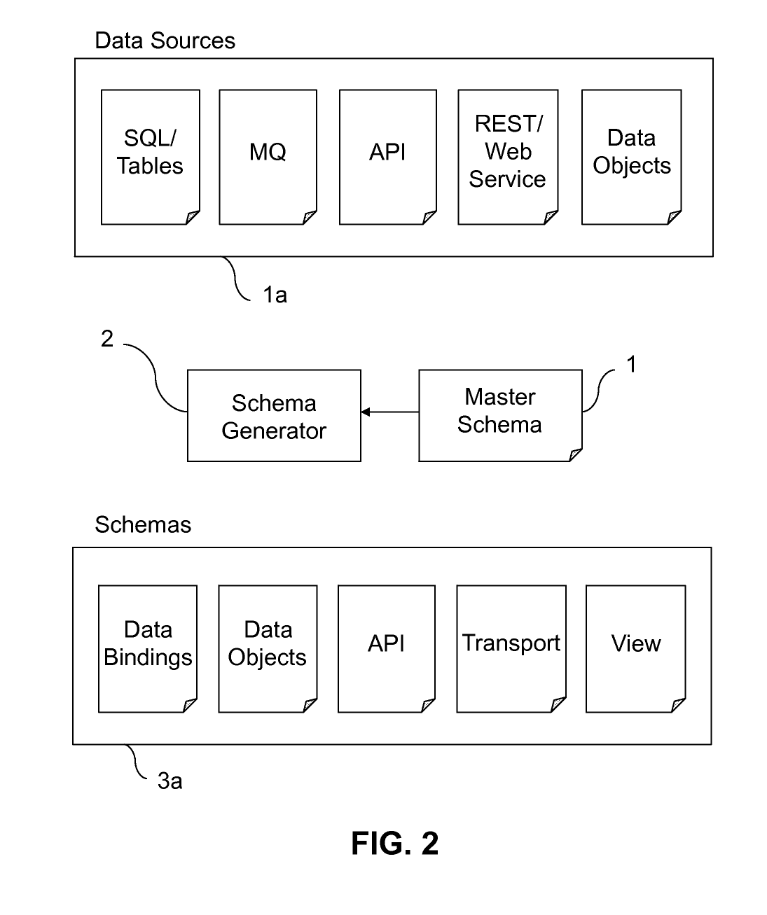

Referring now to FIG. 2, a Master Schema 1 may be created manually, or it may be derived from one or more Data Sources 1a, which comprises SQL table dictionaries, Message Queues (MQs), APIs, REST or Web Service interfaces, data object or class source code, and other structured data sources.

In still another embodiment, part or all of the Master Schema 1 is derived from data objects, data bindings and/or data storages. In still yet another embodiment, part of all of the Master Schema 1 is derived from the API(s) of the enterprise application(s). Deriving a Master Schema 1 from data objects, data bindings and/or data storages captures data structures. Deriving a Master Schema 1 from APIs may capture both data structures and application behavior.

A Schema Generator 2 may generate multiple schemas capable of working with a plurality of heterogeneous components. Schemas 3a may include data bindings such as: SQL scripts or stored procedures and data bindings for tools such as Hibernate or Enterprise Java Beans (EJBs); data object or class source code; APIs, a Transport layer for transporting data between data objects on a server and data objects on one or more clients; and bindings between data objects and views such as graphic user interface (GUI) components, e.g., panels, combo boxes, lists, dialog boxes, grids, buttons, etc.

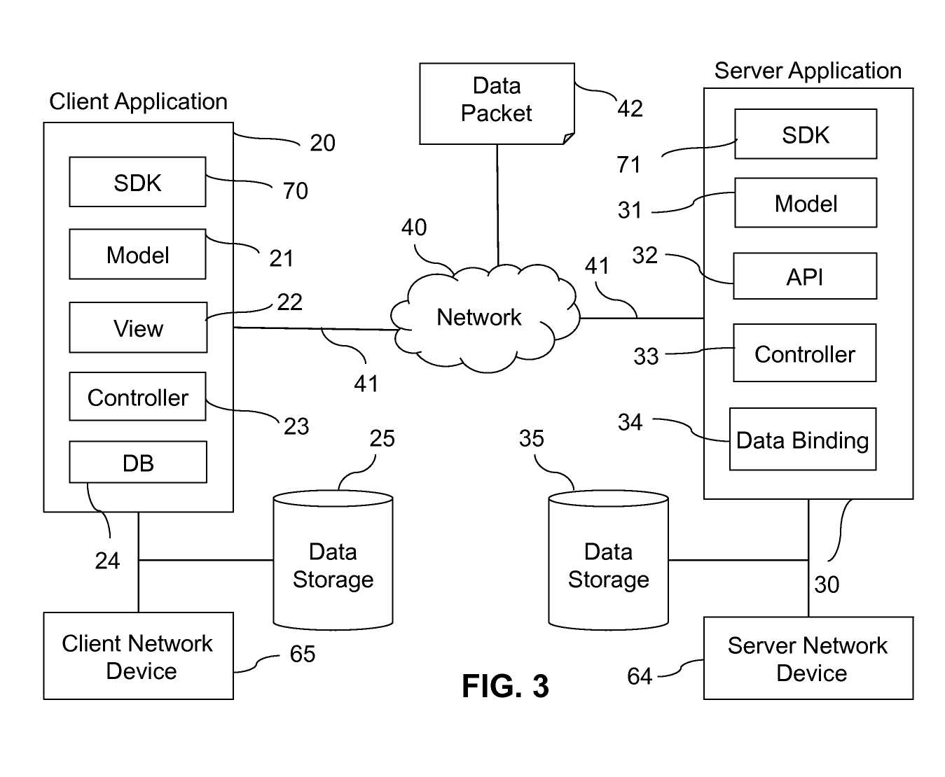

Referring to FIG. 3, a distributed application may be a Server Application 30 or a Client Application 20, wherein each of the Server Application 30 and the Client Application 20 is operable on a computer system such as a personal computer, a tablet computer, a laptop, a personal digital assistant, a mobile phone, a web appliance, and the like. For the purposes of clarity, it is noted that the Client Application 20 is operated via at least one client network device 65 and the Server Application 30 is operated via at least one server network device 64. While it is an object of the present invention to resolve development challenges of heterogeneous mobile devices running on Android (Java), iOS (Objective-C), and other mobile devices (e.g., Chrome), it is within the spirit of the present invention that a Client Application 20 may also be a web application or a GUI application among other possible embodiments by providing a common data model. In the illustrated embodiment, the distributed applications 20, 30 depict a common Model-View-Control (MVC) architecture. It is contemplated, however, that the present invention may also facilitate other architectures or design patterns in addition to MVC, depending upon embodiment.

The Server Application 30 comprises at least one of a Model 31, an API 32, a Controller 33, a Data Binding (DB) module 34, and a SDK 71, as well as any source or object code of the SDK 71. The SDK 71 can also contain an external compiler or other build tools used to build the Server Application 30. The API 32 may be derived from the Model 31. Similarly, the Client Application 20 comprises at least one of a Model 21, a View 22, a Controller 23, a DB module 24, and a SDK 70, as well as any source or object code of the SDK 70. The SDK 70 can also contain an external compiler or other build tools used to build the Client Application 20. The Model 21 is orthogonal to the View 22 and the Controller 23 such that the present system comprises an orthogonal model and requires the minimal amount of code changes. Additionally, each of the Server Application 30 and the Client Application 20 may comprise Data Storage 25, 35. The Data Storage 25 of a Client Application 20 and the Data Storage 35 of the Server Application 30 may be any type of storage such as an SQL database, an object store, and unstructured data storage system, e.g., MongoDB, or a cache among other possible storage types.

In one embodiment, the Data Storage 25 of a Client Application 20 facilitates a two-phase commit where changes to data are saved locally on the Client Application 20 in the Data Storage 25. The Client Application 20 pushes changes to the Server Application 30, the two-phase commit facilitating “store and forward” operations and providing a means of “walking forward” when a change occurs while the Client Application 20 is not connected to a network, or has an unreliable, network connection. In another embodiment, fetched network data is delivered directly to the Client Application 20 and/or its Controller 23 such that the Data Storage 25 is not required.

Each of the Client Application 20 and the Server Application 30 is configured to establish a Network Connection 41. In this way, the Server Application 30 and the Client Application 20 are connected to a Network 40 and can exchange data with Data Packets 42 over a packet switched network. Non-limiting examples of communication networks include Ethernet, USB, Firewire, a cellular network, a local area network (LAN), a wide area network (WAN), the Internet, Plain Old Telephone Service (POTS) networks, Bluetooth, WiMAX, WiFi, or a combination of such networks.

Currently, when a developer needs to change the data model of a distributed application, the change often impacts many parts of the distributed application. For example, a simple change such as adding “Address Line 2” to a data structure for a mailing address would necessarily affect the Data Storage 35, the DB module 34, the Model 31 and the API 32 of the Server Application 30. The change may also affect the structure of Data Packets 42, and the serializers that write them and the parsers that read them. Similarly, the change would affect the Client Application 20 by requiring changes to its DB module 24, Model 21, and View 22. In heterogeneous systems with a plurality of heterogeneous Client Applications, e.g., Android devices, iOS devices, web servers, etc., such a small change has a fairly substantial impact on the overall code base.

In operation, a developer may make a change to the Master Schema 1, regenerate the Schema(s) 3 using the Schema Generator 2, and provide the Schema 3 to the Schema Enforcer 6, wherein the Schema Enforce 6 is a source code compiler. Alternatively, the Master Schema 1, containing annotations, may be directly provided to the Schema Enforcer 6. The developer may then modify the Source Code 5, and use the Schema Enforcer 6 to ensure that the changes made to the Source Code 5 are compliant.

An ordinary person skilled in the art will appreciate that the changes to the Source Code 5 may impact the Data Storage 35, DB module 34, Data Model 31 and API 32 of the Server Application 30. Such a change would also impact the DB module 24, Data Model 21, and View 22 of each Client Application 20. The ability of the Schema Enforcer 6 to provide useful reporting to ensure that the Source Code 5 is in compliance with the Schema 3 can dramatically reduce the time it takes to write, test, and troubleshoot Source Code 5 in a distributed system.

In another embodiment of the present invention, the impact to the Source Code 5 in a scenario such as adding “Address Line 2” to a data structure for a mailing address can be radically simplified by the use of Schemas 3 and Source Code Generators 4. More specifically, the Source Code Generators 4 can automatically re-generate or modify the Source Code 5 related to the Server Application's 30 Data Storage 35, DB module 34, Data Model 31 and API 32, each Client Application's 20 DB module 24, Data Model 21, and View 22, and any changes required of serializers, parsers, Data Packets 42, or other data transport structures.

In this way, making changes to the Master Schema 1 allows a software developer to re-generate or modify code automatically and use the Schema Enforcers 6 to ensure that changes to the Source Code 5 made by the Source Code Generator 4 are in compliance. In this embodiment of the present invention, therefore, a developer can rapidly modify and test code without the expense of large software engineering and quality assurance teams.

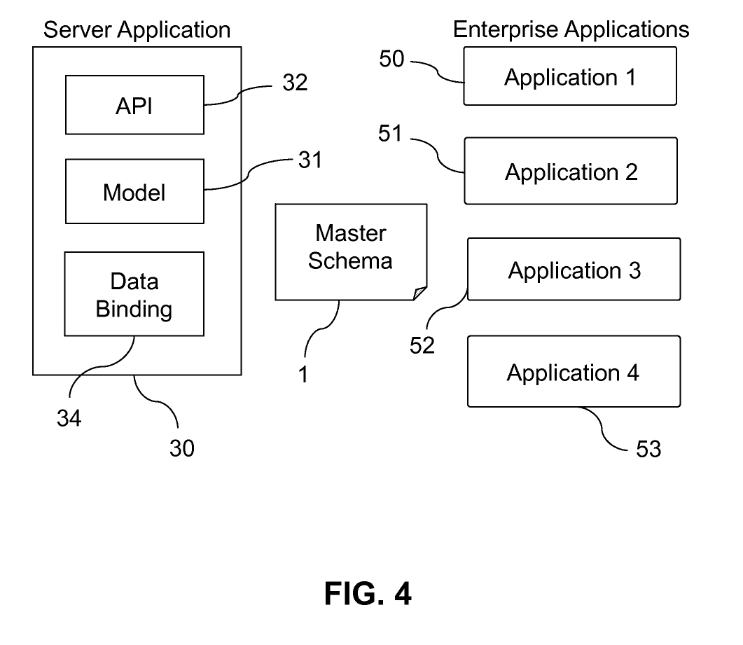

Referring to FIG. 4, the Master Schema 1 may be derived from a plurality of Enterprise Applications 50-53. The Source Code Generator 4 as described in FIG. 1 may generate or modify the Model 31, API 32 and DB module 34 of such that the Server Application 30 becomes a unified interface to a plurality of enterprise applications 50-53. The Client Application 20 of FIG. 2 over a Network 40 establishes a single Network Connection 41 with the Server Application 30, and thereby eliminates the need for a resource and connection constrained wireless device such as a mobile phone or tablet from needing to establish separate communications with a plurality of enterprise applications 50-53.

As described above, the present invention comprises a computer system within which it comprises the computer program of the present invention. Without limitation, the computer system comprises a personal computer, a tablet computer, a laptop, a personal digital assistant, a mobile phone, a web appliance, and other machine capable of executing instructions that specify actions to be taken by that machine. While only a single machine is illustrated, it is contemplated that the machine operates as a standalone device or jointly as a collection of machines to execute a set of instructions to perform any one or more of the methods discussed herein.

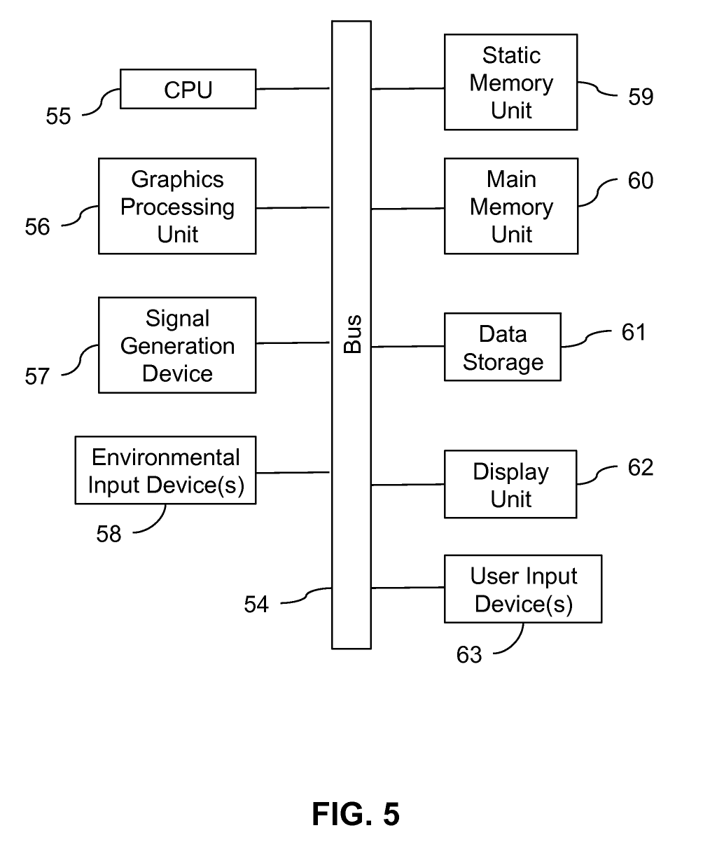

Accordingly, the computer system as shown in FIG. 5 comprises a processor, e.g., a central processing unit (CPU) 55, a graphics processing unit 56, a main memory unit 60, and a static memory unit 59, wherein the foregoing components communicate with each other via a bus 54. The computer system may further comprise a display unit 62, a user input device 63, e.g., keyboard and mouse, a data storage unit 61, a signal generation device 57, e.g., speakers, a network interface device, and an environmental input device 58, e.g., Global Positioning System (GPS) receiver, sensors, camera, microphone, etc.

The data storage unit 61 includes a machine-readable medium on which is stored one or more sets of data structures and instructions, e.g., computer program, software, application, etc., embodying or utilized by any one or more of the methods or functions described herein. The instructions may also reside, completely or partially, in one or more memory units and/or within the processor during the execution thereof by the computer system, the memory units and the processor also constituting machine-readable media.

The instructions may be transmitted or received over the Network 40 using a transmission medium. More specifically, the instructions may be transmitted using the network interface device and any number of transfer protocols, e.g., HTTP. The term “transmission medium” as used herein comprises any intangible medium that is capable of storing, encoding, or carrying instructions for execution by the machine, and includes digital or analog communications signals or other intangible media to facilitate communication of such software.

As will be understood by those familiar with the art, the present subject matter may be embodied in other specific forms without departing from the spirit or essential characteristics thereof. Likewise, the particular naming and division of the portions, modules, agents, managers, components, functions, procedures, actions, layers, features, attributes, methodologies, and other aspects are not mandatory or significant, and the mechanisms that implement the present subject matter or its features may have different names, divisions, and/or formats.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for enforcing a data model for a distributed application in a software development, comprising:
at least one client network device operating a client application;
said client application having a first data model, a view, a controller, and a first data binding module;
at least one server network device operating a server application;
said server application having a second data model, a first application programming interface (API), a controller, and a second data binding module;
a master schema describing a third data model, a third data binding module, a data structure, a second API, an API introspection facility, and a data object;
said client application, said server application, and said master schema in communication over a network;
a source, code for each of said first data binding module, said second data binding module, said first data model, said second data model, said first API, and said view;
at least one of a schema generator configured to consume said master schema and create as one new schema; and
a source code generator configured to consume at least one of said at least one new schema and said master schema and to generate said source code, wherein said source code is in compliance with said third data model.

2. The system of claim 1, further comprising a schema enforcer that is configured to consume said at least one new schema, said master schema, and said source code and to ensure said source code is in compliance with said data third model.

3. The system of claim 1, wherein said master schema comprises annotations, further wherein said source code generator uses said annotations to identify relevant portions of said master schema to generate or modify said source code.

4. The system of claim 2, wherein said schema enforcer comprises at least one source code compiler, a database binding framework, a data marshaller, and an interpreter.

5. The system of claim 1, wherein said at least one new schema comprises a fourth data binding module, a third API, a second data object, a transport, and a second view.

6. The system of claim 1, further comprising a data storage in communication with said client application, wherein said data storage saves changes to data locally on said client application in said data storage, thereby allowing said client application to transmit said changes to said server application.

7. The system of claim 1, further comprising a data storage in communication with said server application.

8. A system for enforcing a data model for a distributed application in a software development, comprising:
at least one client network device operating a client application;
said client application comprising a first data binding module, a first data model, a view,
at least one server network device operating a server application, wherein said server application comprises a plurality of enterprise applications;
said server application comprising a second data binding module, a second data model, and an API;
said client application in communication with said plurality of enterprise applications via said server application over a network, wherein said at least one network device interacts with said plurality of enterprise applications in a type-safe manner;
a master schema describing a unified data model, said unified data model derived from individual data models of said plurality of enterprise applications; and
a source code for each of said first data binding module, said second data binding module, said first data model, said second data model, said API, and said view, wherein said source code reflects said unified data model.

9. The system of claim 8, further comprising a schema enforcer that is configured to consume said source code and to ensure said source code is in compliance with said unified data model.

10. The system of claim 8, wherein said master schema comprises annotations, further wherein said source code generator uses said annotations to identify relevant portions of said master schema to generate or modify said source code.

11. The system of claim 9, wherein said schema enforcer comprises at least one source code compiler, a database binding framework, a data marshaller, and an interpreter.

12. The system of claim 8, further comprising a data storage in communication with said client application, wherein said data storage saves changes to data locally on said client application in said data storage, thereby allowing said client application to transmit said changes to said server application.

13. The system of claim 8, further comprising a data storage in communication with said server application.

14. A non-transitory computer storage medium, comprising executable instruction, which when executed by a computer, cause said computer to:
create a master schema, wherein said master schema describes a data model, a data binding module, a data structure, an API, an API introspection facility, and a data object;
establish a network connection among a first distributed application, a second distributed application, and said master schema;
make changes to said master schema to generate an updated master schema and/or generate a new schema via a schema generator; and
read said master schema, said updated master schema, and said new schema and generate a source code via a source code generator, wherein said source code is consistent with said master schema, said updated master schema, said new schema, and said data model.

15. The non-transitory computer storage medium of claim 14, further comprising instructions for providing said updated master schema and/or said new schema to a schema enforcer.

16. The non-transitory computer storage medium of claim 15, further comprising instructions for compiling said updated master schema and/or said new schema via annotations relevant to said schema enforcer.

17. The non-transitory computer storage medium of claim 16, further comprising instructions for modifying a source code to generate an updated source code; and
ensuring that said updated source code is compliant with said updated master schema and/or said new schema.

18. The non-transitory computer storage medium of claim 14, further comprising instructions for saving changes to data locally on said first distributed application in a data storage; and
transmitting said changes to said second distributed application.

19. The non-transitory computer storage medium of claim 14, further comprising instructions for establishing said network connection between said first distributed application and a plurality of enterprise applications via said second distributed application.
